(19) United States
(12) Patent Application Publication
(10) Pub. No.: US 2011/0274842 A1
(43) Pub. Date: Nov. 10, 2011

(54) CORROSION RESISTANT COATING

(75) Inventor: Robert D. Mott, Vancouver, WA (US)

(73) Assignee: Chemetall Corp.

(21) Appl. No.: 12/808,114

(22) PCT Filed: Dec. 13, 2007
(86) PCT No.: PCT/US2007/087338

§ 371 Date: Jun. 14, 2011

(51) Int. Cl. C09D 5/08; B05D 1/28; C08K 3/10

(52) U.S. Cl. 427/355; 524/407; 524/413; 524/403; 427/428.01

(57) ABSTRACT

A process has been developed which will provide a product that simulates zinc phosphate by providing a corrosion resistant coating on materials including but not limited to, steel, hot dipped galvanized or electrogalvanized metal. The simulated product provides very similar, if not the same, physical and visual attributes as zinc phosphated materials. The process is one, which does not require a convention chemical tank, as it can be roll applied, thereby allowing for broader applications.

### FIELD OF THE INVENTION

The present application relates to corrosion resistant coatings, similar to zinc phosphate coatings, a process for their production, and the application of said coatings. These coatings may be used on galvanized and similar metal surfaces.

### BACKGROUND OF THE INVENTION

Commercially available baths for producing corrosion resistant phosphate coatings were developed during the turn of the century. Iron and steel parts were immersed in a phosphoric acid bath containing iron filings. After approximately two hours, a conversion coating was produced that helped in retarding corrosion.

The coatings are widely used for one or a combination of the reasons, such as to prolong the life of an organic coating; to provide excellent paint or solid film lubricant resin bonding; to improve corrosion protection by providing a good base for absorbing and retaining rust preventing materials; and to provide an excellent base for lubricants and drawing compounds.

Present day phosphate coating solutions are dilute aqueous solutions of phosphoric acid and other chemicals which, when applied to the surface of a metal react with the metal surface forming an integral layer on the surface of the metal of a substantially insoluble phosphate coating, amorphous or crystalline. Generally, the crystalline coatings are preferred.

Typically the solutions include phosphate ions, zinc and other metal ions to provide specific characteristics desired in the final coating. Other ions typically present may be nitrate, nitrite, chlorate, fluoroborate or silicofluroride. A typical phosphating process is comprised of the following sequence: (1) cleaning and conditioning, (2) phosphating and (3) post treating. Rinses are generally employed between each step to prevent any carry over of materials to the next step.

U.S. Pat. No. 4,838,957 describes a zinc phosphating process employing aqueous phosphate solution containing zinc ion, phosphate ion, manganese ion, fluoride ion and a phosphating accelerator.

In U.S. Pat. No. 4,865,653 phosphate coating solutions are described in which the accelerator employed is hydroxylamine sulfate, which is employed so as to alter the morphology of the resulting coating from platelet to a columnare and/or nodular structure.

U.S. Pat. No. 5,261,973 discloses zinc phosphate coatings for metal surfaces and phosphating process. Concentrates containing (a) hydroxylamine sulfate and (b) zinc, nickel, manganese and phosphate ions are formulated into aqueous coating solutions for treating metal surfaces, including ferrous, zinc and aluminum surfaces.

However, all the processes provide for the use of convention chemical tanks. Accordingly, a need exists for a process that would simulate the zinc phosphate coatings, but which would not require the use of a chemical tank, but can be roll applied, therefore having broader use, such as to coil coaters and metal coating lines.

### SUMMARY OF THE INVENTION

The present application relates to corrosion resistant coatings, similar to zinc phosphate coatings, a process for their production, and the application of said coatings. These coatings may be used on galvanized and similar metal surfaces.

A process has been developed which will provide a product that simulates zinc phosphate by providing a corrosion resistant coating on materials including but not limited to, steel, hot dipped galvanized or electrogalvanized metal. The simulated product provides very similar, if not the same, physical and visual attributes as zinc phosphated materials. The process is one, which does not require a convention chemical tank, as it can be roll applied, thereby allowing for broader applications.

According to one embodiment, a product which simulates zinc phosphate coatings is comprised of a combination of a polymer, dye and silica. In addition to those components, water may also be included in the simulated material.

In a further alternative embodiment of the invention, the mixture is agitated and applied to a piece of metal either by a roll coater, or by a flood and squeegee method.

The various features of novelty which characterize the invention are pointed out with particularity in the claims annexed to and forming a part of this disclosure. Changes to and substitutions of the various components of the invention can of course be made. The invention resides as well in sub-combinations and sub-systems of the elements described, and in methods of using them.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

A process has been developed which provides a product that simulates zinc phosphate on materials including but not limited to, steel, hot dipped galvanized or electrogalvanized metal. The simulated product provides very similar, if not the same, physical and visual attributes as zinc phosphated materials. The process is one, which does not require a convention chemical tank, as it can be roll applied, thereby allowing for broader applications.

In one embodiment of the invention, polymer material, dye and silica are combined, with water, agitated and then applied to the material to be coated. The polymer to be used can be one of many available and known in the art, particularly those that are film forming polymers. Examples of such film forming polymers includes, but is not limited to, acrylic polymers, such as polyacrylates and methacrylates, polyflurocarbons, vinyl ether copolymers, and poysaccharides. In addition, the film forming polymers may be formulated in a compound that includes additional components. For instance, included in the polymer component would be polymers that are combined with lubricants. A polymer material that is blend of an acrylic polymer and lubricants, is an acceptable component for this process and the resulting product. An example of such a material is BRUGAL GM4-SRF(A)™, which is a proprietary blend of an acrylic polymer and lubricants (ProCoat, Inc., Barcelona, Spain).

An additional component of the present invention a dye or pigment which is used in an amount sufficient to result in providing the simulated material the proper hue, so that the material treated with the simulated zinc phosphate treatment has the same visual attributes as a materials actually treated with zinc phosphate. Any dye that is known within the art would be acceptable, and combination of dyes would work as well. Examples of the same include, but are not limited to, carbon black, ceramic, titanium dioxide, and combinations thereof. In addition to just straight dyes, the dye component can be added as a combination. For instance, one product that is a combination of a dye and polymer that can be used is BRUGAL GM4-SRF(A) Black (ProCoat, Inc., Barcelona, Spain). Depending on the coating weight applied, the coating appearance will vary from grey to black.

In addition to the polymer and dye, silica is a component of the simulated zinc phosphate material. The silica is added to increase the adhesion of the current product to the metal to which it is to be applied. Any silica may be used, with the preferred form to be granular with a particle size of from about 2 to about 10 microns, preferably from about 5 to about 7 microns. An example of such a silica is Davisil® (Grace Davison, Deerfield, Ill.). As an alternate embodiment, any inert particle that has a particle size of from about 2 to about 10 microns would most be able to be substituted for the silica, and would be known to those skilled in the art.

An additional material that may be part of the simulated zinc phosphate coating is a passivation agent. Any such agent would work, including but not limited to chromium, zirconium, titanium or cerium salts, silanes, and combinations thereof. Included as well, would be combinations or solutions of the agents, such as a phosphochromate solution. An example of such a material is BRUGAL GM-4(B)™, which is a proprietary blend comprising chromic acid, chromium oxide, zinc salt and phosphoric acid (ProCoat, Inc., Barcelona, Spain).

The above components are combined by stirring or agitation. One embodiment of the invention provides for the combination of three initial ingredients in a ratio. The polymer may be present in an amount of from about 50 to about 70 percent by weight, preferably from about 55 to about 65% by weight. The second ingredient, the passivation agent, may be present in an amount of from about 10 to about 20% by weight, preferably from about 12.5 to about 17.5% by weight. The dye or pigment is present in an amount effective to provide the desired end color. For most uses, it may be present in an amount of from about 20 to about 30% by weight, preferably from about 22.5 to about 27.5% by weight.

After the three initial ingredients have been combined to form a mix, the silica is then added. The silica should be added in an amount of from about 0.2 to about 1.0 pounds of silica per gallon of the mix. The mixture containing the silica is agitated and then water may be added to get a to a useable consistency. Water may be added as appropriate to insure that the coating is of the correct consistency to allow for roll coating or flow and squeegee application.

The resulting mixture may then be applied to the material to be treated either by a roll coater or by flow squeegee method, both of which are known in the art. The mixture should be applied as a thin coat, and may be applied to metal, including galvanized or similar metal surfaces, typically through a chemcoater and then cured. The result is a corrosion resistant coating that has lubricating and anti-fingerprinting properties. An additional benefit to this process is the lack of requirement of a post treatment step. In conventional zinc phosphate processes, where the coating is applied through a chemical tank, a post treatment rinse step may be employed. The present process eliminates the need for such a step.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

1. A corrosion resistant coating comprising
(a) a film forming polymer in an amount of from 50 to 70% by weight selected from acrylic polymers, polyfluorocarbons, vinyl ether copolymers, poysaccharides or blends of an acrylic polymer and lubricants;
(b) dye selected from carbon black, ceramic, titanium dioxide, and combinations thereof;
(c) silica;
(d) a passivation agent selected from chromium salts, zirconium salts, titanium salts, cerium salts, silanes, and combinations thereof; and
(e) water;
wherein the dye is effective to create on a material treated with the corrosion resistant coating a similar appearance as a material actually treated with a zinc phosphate.

2. (canceled)

3. The corrosion resistant coating of claim 1 which can be roll applied or flow squeegee applied.

4. (canceled)

5. (canceled)

6. The corrosion resistant coating of claim 1 wherein the polymer is present in an amount of from about 55 to about 65% by weight.

7. (canceled)

8. The corrosion resistant coating of claim 7 wherein the passivation agent is present in an amount of from about 10 to about 20% by weight.

9. The corrosion resistant coating of claim 7 wherein the passivation agent chromate is present in an amount of from about 12.5 to about 17.5% by weight.

10. The corrosion resistant coating of claim 1 wherein the dye is present in an amount of from about 20 to 30% by weight.

11. The corrosion resistant coating of claim 1 wherein the dye is present in an amount of from about 22.5 to about 27.5% by weight.

12. A process for producing a corrosion reducing coating comprising
(a) mixing together a polymer which is a film forming polymer in an amount of from 50 to 70% by weight selected from acrylic polymers, polyfluorocarbons, vinyl ether copolymers, polysaccharides or blends of an acrylic polymer and lubricants, a passivation agent and a dye,
(b) adding silica to the mixture of step (a) in an amount of from about 20 to about 100 grams of silica per liter of the mixture (about 0.2 to about 1.0 pounds of silica per gallon of the mixture); and
(c) agitating the mixture of step (b).

13. The process of claim 12 which further comprises applying the mixture from step (c) to a material to be treated.

14. The process of claim 13 wherein the material to be treated is chosen from the group comprising steel, hot dipped galvanized or electrogalvanized metal, or combinations thereof.

15. The process of claim 13 wherein the application is carried out by roll coater or a by flow squeegee method.

16. The corrosion resistant coating of claim 1 further comprising a pigment.

17. The corrosion resistant coating of claim 16 wherein the dye or pigment is effective to create on a material treated with the corrosion resistant coating a similar appearance as a material actually treated with a zinc phosphate.
